(19) United States
(12) Patent Application Publication
(10) Pub. No.: US 2011/0188060 A1
(43) Pub. Date: Aug. 4, 2011

(54) METHOD FOR PREPARING A PROFILE OF A PRINTING SPEED OF A PRINTING MACHINE

(76) Inventor: Eberhard Voss, Buedelsdorf (DE)

(21) Appl. No.: 13/063,489

(22) PCT Filed: Aug. 12, 2009
(86) PCT No.: PCT/EP09/60453

§ 371 Date: Apr. 26, 2011

(30) Foreign Application Priority Data
Sep. 22, 2008 (DE) 102008048278.1

(51) Int. Cl. G06K 15/02

(52) U.S. Cl. 358/1.9

(57) ABSTRACT

For an efficient management of the printing speed in a printing machine, a method has been provided for preparing a profile of a printing speed of a printing machine for printing a plurality of sheets, wherein a print job defining the printing of a plurality of sheets is accepted and analyzed in view of a printing speed for each individual sheet. Subsequently, before printing the sheets of the print job, a profile of the printing speed is prepared for each individual sheet as a function of the printing speed and of the change-over times between different printing speeds of the printing machine. It is also possible to determine the printing speed of the sheet with the lowest printing speed within the print job and, subsequently, adjust a profile of the printing speed for the entire print job to a constant printing speed that corresponds to the lowest printing speed within the print job, with the profile being adjusted before the sheets of this print job are being printed.

### TECHNICAL FIELD OF THE INVENTION

The present invention relates to a method for preparing a profile of a printing speed of a printing machine. In particular, the determination and adjustment of the profile of the printing speed is based on properties of the substrate to be printed, and of the output device of the inks used, and/or on special requirements that are to be met by the produced printed image.

### BACKGROUND ART

Usually, print jobs contain various types of information regarding a document that is to be continuously printed on a plurality of sheets. Such print jobs are usually sent to a printer, accepted by said printer and then processed page by page. Regarding this, it is known to adapt the printing speed of the printer to the requirements of the page that is to be momentarily printed. This procedure makes sense when a change of the speed from page to page does not create a problem, this usually being the case for home or office use. The printing speed is adjusted to the respective requirements of the page to be printed and results from the requirements of the print.

The situation is different with large printing machines, in particular with multi-color printing machines. In printing machines of this type, almost instantaneous speed changes are not easily possible. In contrast with home or office applications, thus a printing speed change from one page to the next is usually not technically expedient.

Reasons for this are, for example, the—in contrast with printers for home use large masses that are being moved such as, e.g., transport rollers or imaging cylinders. The moments of inertia of these moving masses make an instantaneous change of the printing speed difficult and not always practical. A change of the printing speed, e.g., is always connected with higher or lower rotation numbers of the transport rollers, and thus said mentioned moments of inertia must be overcome. Any acceleration, in particular of the transport rollers, is accompanied by a high use of energy and/or time. In addition, a print job is usually divided into groups, so-called batches, such as, for example, groups of eight pages per batch. The size of the groups depends on several factors such as, for example, the format of the pages or sheets to be printed and the length of a print path in the printing machine.

If now a batch contains pages that could be printed at different printing speeds, it is still not desirable to change the printing speed within a batch, because this may lead to registration problems during the overall execution of the print job and in particular within the batch.

In order to avoid problems regarding different required printing speeds within a print job, it is known that certain printing materials that require a lower printing speed will not be cleared for certain printing machines. Another approach simply ignores problems regarding potential registration problems and still performs speed changes sheet by sheet. In yet another approach to a solution, the printing speed of the printing machine is generally decelerated in such a manner that all permitted sheets and printing situations can be handled at the one printing speed.

The first approach to a solution, however, restricts the flexibility of the printing machine in that certain media are not cleared because of the printing speed. The second approach can lead to an excessive wear of the printing machine and to qualitative losses in the printed result. The last approach can, in turn, lead to an inefficient use of the printing machine because it has been decelerated in view of a potentially achievable printing speed.

Among other things, DE 10250194A1 relates to a device and a method for controlling an electro photographic printer or copier, with nominal points in time being set and monitored for controlling the printing of each individual sheet. Furthermore, a method and a device for switching between two modes of operation have been disclosed, which are meant to ensure the highest-possible throughput.

EP 1 339 218 A2 discloses a printer and a method comprising color and monochrome printing processes that check whether a page is to be printed as a color print or as a monochrome print. The printing process of a respective page to be printed is determined in view of the presence of subsequent pages and in view of the number of pages to be printed.

### SUMMARY OF THE INVENTION

Therefore, the object of the present invention is to provide an efficient management of the printing speed in a printing machine, in particular, an electro photographic multi-color printing machine.

In accordance with the invention, this object is achieved by a method in accordance with claims 1 and 7. Additional modifications of the invention are obvious from the subclaims.

In the method in accordance with the invention in particular, a print job is initially accepted, said print job defining the printing of a plurality of sheets or pages. The print job may be composed of individual sheets that should be printed at different printing speeds. For example, it is known that paper sheets displaying different weights per unit area and/or coatings can be printed at different maximum printing speeds. As a rule, films also permit different maximum printing speeds. However, also the use of certain toners such as, for example, a high-gloss clear toner on a sheet may require a lower printing speed for this sheet. Of course, it is also possible for other parameters to restrict the maximum printing speed of a sheet.

During an additional step of the method, these restrictions of the printing speed are analyzed for each individual sheet of the print job. By means of this thusly analyzed print job, a profile of the printing speed of the entire print job is prepared before the sheets of the print job are being printed, i.e., as a function of the printing speed of each individual sheet and of the change-over times between various printing speeds of the printing machine.

Based on the aforementioned restrictions for changing the printing speed in a printing machine it is obvious that not only the presence of printing materials to be printed at different speeds but also their distribution within a print job can be an additional determinant as to how the profile will look at the end and whether a change-over of the printing speed is even useful or not. Under certain circumstances it may be practical to constantly maintain the printing speed at a speed that corresponds to the sheet with the slowest speed because a change-over of the printing speed always contains a time component, i.e., the printing speed cannot be switched instantaneously. As a result of this, depending on the composition of the print job, a change-over may not be appropriate. A clear example is a print job wherein only one page within the print job allows a higher printing speed, and an acceleration or deceleration of the speed takes up considerably more time than would be saved by the higher speed for the one sheet. If a printing speed change-over within the print job is not considered practical, the printing speed of the entire print job is adjusted to a constant value that corresponds to the sheet with the slowest speed.

The object of another embodiment of the invention is to keep the printing speed within a print job generally constant. To achieve this, a method has been provided for preparing a profile of a printing speed of a printing machine for printing a plurality of sheets, said method comprising the steps of accepting a print job defining the printing of a plurality of sheets, subsequently analyzing the print job in view of a printing speed for each individual sheet, determining the printing speed of the sheet with the lowest printing speed within the print job, and, finally, adjusting the profile of the printing speed for the entire print job to a constant printing speed that corresponds to the lowest printing speed within the print job, with the profile being adjusted before the sheets of this print job are being printed. This method has the advantage that it can be very easily implemented and that it does not make special demands on the printing machine in view of processing the print job because a constant speed is used for printing for the entire print job.

When analyzing the print job it is possible to take into consideration various parameters such as, e.g., the weight, the shape, the material, the stiffness, a coating, etc., of the sheet to be printed. It is also possible to consider other parameters of the print job such as, e.g., monochrome printing or color printing, a desired gloss of a picture which is produced in the fusing unit of the printing machine, or the addition of custom inks.

In order to compute any potential time savings, the duration of time for the fastest-possible processing of the print job is required first. This value is compared with the duration of processing the print job that is handled with the printing speed of the sheet that is the slowest to be printed. The difference of these two times represents the theoretically possible time savings. By introducing a threshold value for time savings, said threshold value, for example, being a function of the printing machine parameters such as inertia of the rollers or of the path length, it is possible to define the value for time saved, as of which value a changing of the printing speed is considered practical. This threshold value may be a fixed, prespecified time value and may assume different values for one and the same print job, depending on the printing machine that is being used.

This has the advantage that such an adjustment of the threshold value can be implemented in a simple manner and thus represents a cost-effective solution.

In another embodiment, the threshold value may be a percentage of the printing duration of the entire print job at a constant speed that is adjusted to the print speed of the slowest sheet. This percentage may be, for example, between 10% and 20%. An adjustment of a threshold in this way has the advantage of a dynamic adaptation of the processing of a print job to the special circumstances of said print job.

In one embodiment, the step of analyzing comprises the retrieval of a speed parameter, that is allocated to each sheet based on the sheet properties, specified within the print job. The retrieval of this speed parameter has the advantage that the print job can be rapidly and simply analyzed with the use of this parameter within the method.

In accordance with another embodiment of the method, the step of analyzing comprises the determining of the printing speed for each individual sheet based on the material properties of the sheet and/or as in another embodiment based on the image to be printed on the sheet. Likewise, the method may comprise the analyzing and determining of the printing speed based on the fusing unit requirements, this being the case, for example, when the print is to meet special gloss requirements.

The determination of the printing speed with the use of the aforementioned parameters has the advantage that the method can be easily adapted to the actual requirements in a printing machine.

Preferably, the printing machine is a multi-color printing machine comprising a plurality of printers and comprising, in another embodiment, a duplex path.

Previously, the invention was explained in detail with the use of differently illustrated embodiments, without being specifically restricted to the illustrated embodiments.

### BRIEF DESCRIPTION OF THE DRAWINGS

Hereinafter, the invention will be explained in greater detail with reference to the drawings.

They show in

FIG. 1a schematic side view of a printing machine;

FIG. 2a flow chart of a method in accordance with the invention; and

FIG. 3a flow chart of an alternative method in accordance with the invention.

### DETAILED DESCRIPTION OF THE INVENTION

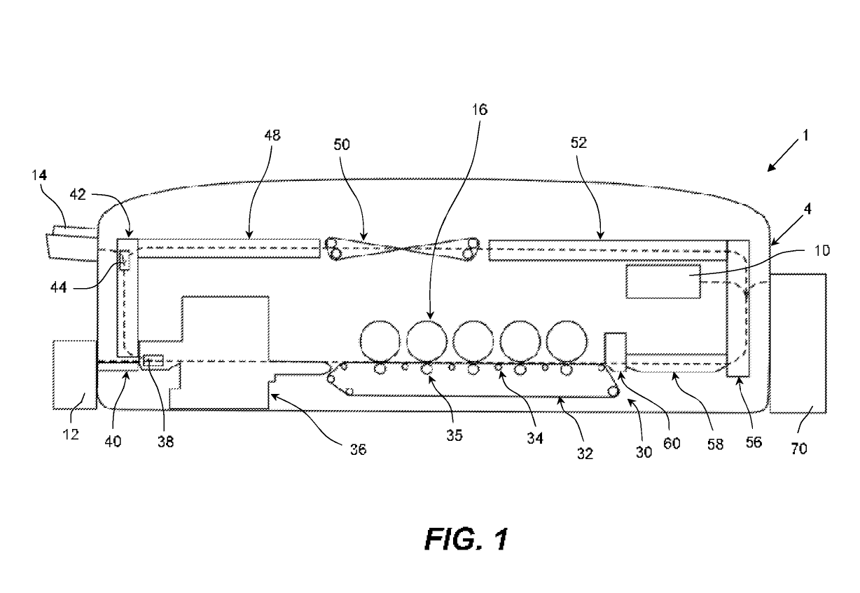

FIG. 1 shows a schematic side view of an exemplary, electrophotographically working printing machine 1 that is designed for sheet printing and wherein a method in accordance with the invention can be performed. The illustrated printing machine 1 is a printing machine for multi-color printing. In order to simplify the illustration, lateral housing parts that, as a rule, prevent a view inside the printing machine 1, have been left off.

The printing machine 1 in accordance with FIG. 1 comprises a housing 4, a sheet cassette 10 accommodated inside the housing 4, as well as an external sheet cassette 70.

The printing machine comprises electrophotographically working printing units 16. The printing units 16 are arranged in such a manner that they print directly on a sheet. For this reason, the printing units are provided directly above a first transport unit 30 that comprises a transport belt 32 guided around a plurality of rollers 34. Rollers 35 are provided opposite the printing units 16, said rollers pressing a sheet transported through the transport unit 30 against a corresponding transfer element of the printing units 16 in order to allow an application of toner directly to a sheet. Consequently, image transfer stations are formed between the printing units 16 and the rollers 34 located opposite them.

The first transport unit 30 in accordance with FIG. 1 has a length such that a sheet, before reaching the first printing unit 16, can be completely supported in longitudinal direction by the transport belt 32. In the same manner, the sheet, after moving past the last printing unit 16, is to be completely supported in longitudinal direction by the transport belt 32. In the embodiment in accordance with FIG. 1, a total of five printing units are provided. Also, the distances between the printing units are chosen such that a sheet may be in only one image transfer station at a time. Thus, at least six sheets may be on the transport belt at the same time. If one sheet, respectively, is added in an alignment unit and in a fusing unit, the result is group sizes of 8 sheets that are within one print run at the same time. Of course, the group size may also be larger when smaller formats are being used.

Viewed in sheet transport direction, the printing machine comprises a fusing station 36 with a switch 38 downstream of the first transport unit. Furthermore, corresponding transport units 40, 42, 48, 52 and 56, as well as a sheet-turning unit 50, are provided between the transport units 48 and 52. A switch 44 is integrated in the region of the transport unit 42.

Furthermore, the printing machine 1 in accordance with FIG. 1 comprises a preliminary alignment unit 58 as well as another alignment unit 60.

With reference to FIG. 1, the operation of the printing machine will be explained in greater detail hereinafter. At the start of the printing process, a sheet to be printed is fed into the sheet transport path said path being indicated in dashed lines either from the sheet cassette 10 or from the external sheet cassette 70, this again being shown in dashed lines. In particular, the sheet to be printed is transported out of the sheet cassette 10 to the vertically extending transport unit 56. Said transport unit first transports the sheet in vertical direction in order to deflect it into the horizontal direction at the lower end and to transport it to the pre-alignment unit 58. In said pre-alignment unit, the sheet is pre-aligned and subsequently transferred to the alignment unit 60 where an additional alignment takes place.

Following the fine alignment of a sheet in the alignment unit 60, said sheet is transferred to the first transport unit 30. In the embodiment in accordance with FIG. 1, the respective printing units 16 sequentially transfer each a color separation image directly to a sheet. During this process, the first transport unit is operated at essentially uniform speed during this toner transfer, and said speed being determined in accordance with the method of the invention, said method being described hereinafter. Each of the printing units is controlled in such a manner that the corresponding toner separation image is transferred to the sheet to be printed at the correct point in time. This has also been known as the image-follows-paper process.

In the fusing station 36, the toner image that has been transferred to the sheet is fused by the application of heat and pressure. During the fusing process, the sheet is transported through the integral transport unit of the fusing station 36. Following the fusion by the application of heat and pressure, the sheet is cooled in a cooling section of the fusing station 36. At the end of the fusing station 36, the thusly printed sheet is directed by the switch 38 either to the transport unit 40 or to the transport unit 42. If the sheet is directed to the transport unit 40, said sheet is subsequently transported to the output tray 12, and the printing process for this sheet is completed. If the sheet is directed to the transport unit 42 by the switch 38, said transport unit transports the sheet upward in vertical direction. At the upper end of the transport unit, the switch 44 then directs the sheet either in the direction of the tray 14 or the transport unit 48. Usually, the sheet is directed toward the tray 14 if the print quality is to be checked with the use of a corresponding sheet from the print job during an existing print job.

If the sheet is directed toward the transport unit 48, said sheet is usually intended for duplex-printing, as will be described hereinafter. The transport unit 48 transports the sheet to the sheet-turning unit 50, in which the sheet is rotated about its longitudinal axis. At the end of the sheet-turning unit 50, the sheet is transferred to the transport unit 52 that continues to transport the sheet to the vertically extending transport unit 56. By way of the transport unit 56, the sheet is then again transported back to the pre-alignment unit in order to prepare the turned-over sheet for a renewed toner application in the image transfer station. Then the image transfer process is the same as described above, with the rear sides of the sheet now being provided with a corresponding toner image. This is followed again by corresponding fusing and cooling of the sheet, and, thereafter said sheet is output to the sheet cassette 12 or to the tray 14.

Even though the fusing unit has been described above as a unit working with the application of heat and pressure, said fusing unit may also provide, for example, contactless fusing whereby only the application of heat is used.

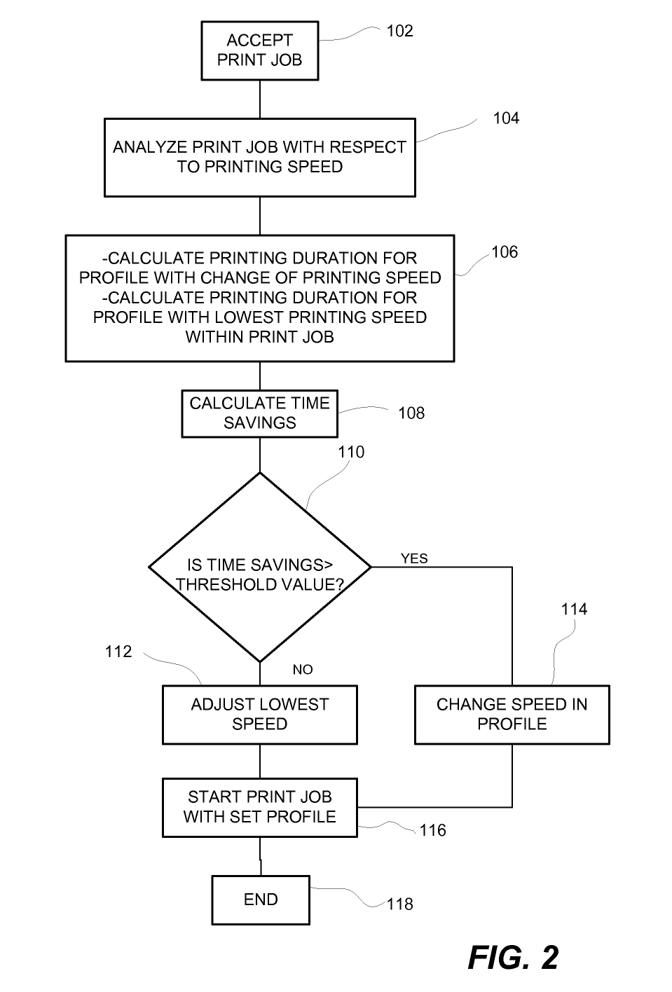

FIG. 2 shows, schematically, a flow chart for an inventive method for preparing a profile of the printing speed of a printing machine. The method for preparing a profile of the printing speed of a printing machine as described above will be explained in greater detail with reference to FIG. 2.

First, in block 102, a print job is accepted, said print job containing information regarding a document that is to be continuously printed on a plurality of sheets. Usually, this print job is accepted by a printer driver or the front end of the printing machine. Usually, the print job contains, among other things, information regarding, for example, the number and type of sheets to be printed, a format that is being used, the use of inks and data regarding the gloss settings for the sheets of the document that are to be printed.

In block 104, during the next step of the method, the print job is analyzed in view of the printing speeds of the respective sheets. The result of this analysis produces a speed distribution of all the sheets of the print job that are to be printed. For this, the maximum printing speed is determined for each sheet within the print job. This is accomplished, for example, on the basis of a speed parameter allocated to each sheet, the material properties of the sheet, the properties of the printing machine, and/or the type of image to be printed.

Furthermore, a division into batches takes place with the use of the information in the print job regarding the number of sheets to be printed. Speed changes are not allowed within a batch so that, for example, the speed of all the sheets within a batch is set to the same value, said value corresponding to the lowest value for the sheets in the batch. A batch defines, for example, a number of sheets in such a manner that a print path of the printing machine is fully loaded. With a given path length, the number of sheets in a batch depends thus on the format of the sheets to be printed. A preliminary division into batches is expedient, because the printing speed should not be changed within a batch. This division is done on the basis that no sheet is to be printed at a printing speed that is higher than the maximum determined printing speed for this sheet. As opposed to this, slower printing is allowed without problem.

In block 106, during a subsequent step, the theoretical printing duration is calculated for the entire print job. On the one hand, the calculation comprises a calculation of the printing duration on the basis that one or more change-overs of the printing speed within the print job will be allowed, and, on the other hand, a calculation of the printing duration on the basis that all the sheets are printed at an unchanging printing speed that corresponds to the sheet with the lowest maximum printing speed.

The first calculation includes the change-over times that are required for a change between different speeds. Said speeds comprise, among other things, the actual times for accelerating/decelerating the involved drives as well as, if necessary, waiting times for batches of sheets that should be introduced into the print path only when the previous batch has completely left the print path. For a duplex-print, it would be preferably if the batch has completely passed through recto-printing as well as verso-printing. For example, these change-over times can have the effect that, with a specific distribution of the printing speeds of individual sheets, a changing of the printing speed cannot achieve a time advantage compared with printing at constantly low speed. It is possible to include even more parameters in this calculation such as, for example, a statistical increase of the error frequency in sheet handling caused by speed change-overs and waiting times.

Consequently, in this step, a value for the entire printing duration of each profile is determined for at least two preliminary profiles of the printing speeds of the print job. The verifications explained in the next steps are determinant as to which of these profiles will ultimately be used.

In block 108, these values for the entire printing duration of each profile are used to calculate any theoretically possible time savings compared with a profile of a constantly low printing speed.

Also, the method provides for setting a threshold value. For example, this threshold value could be a percentage time value of the printing duration for the profile of a constant, low printing speed. Alternatively, however, it is also possible to prespecify a fixed time value or another threshold value that depends on the number of sheets of the print job, for example.

In block 110, the theoretically possible time to be saved is now compared with the threshold value. If the saved time is greater than the threshold value, i.e., for example above the desired percentage, the speed change is included in the profile of the printing speed for the print job, and a corresponding profile is prepared in block 114.

However, if the time to be saved is less than the threshold value, no speed changes are included in the profile in block 112 and, instead, the printing speed in the profile is set to a constant value, said value corresponding to the sheet with the lowest printing speed.

Subsequently, corresponding to the previously set speed profile, printing of the print job is started in block 116, and, thereafter, the process finishes in block 118. As is obvious from the flow of this process, the entire print job is analyzed first, and then the profile of the printing speed for the entire print job is adjusted before printing of the print job is started.

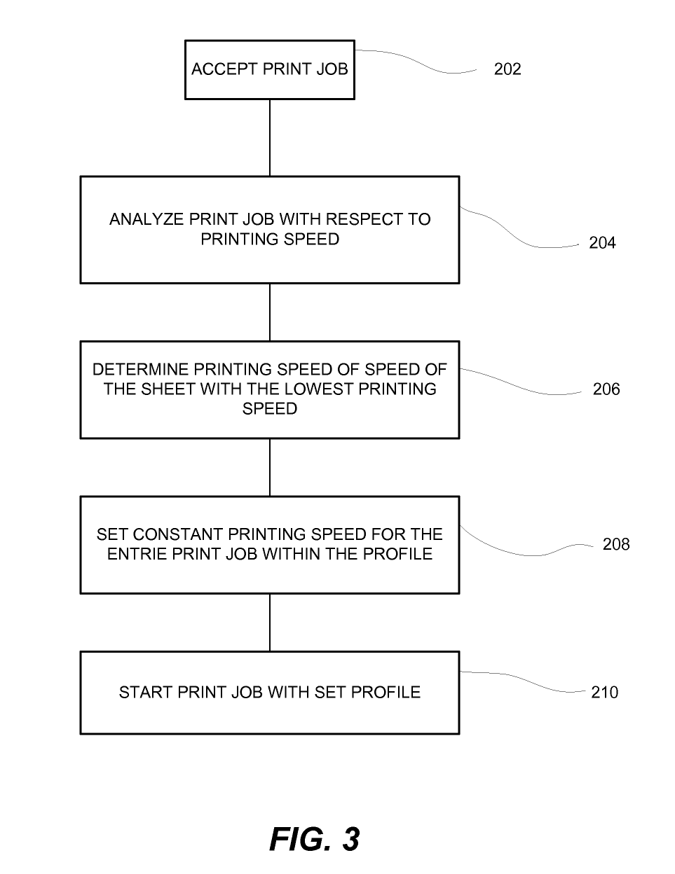

FIG. 3 is a schematic flow chart for an alternative method for preparing a profile of the printing speed of a printing machine.

In block 202 that corresponds to block 102 in accordance with FIG. 2, again, a print job is accepted.

In block 204, that is analogous to block 104, the print job is analyzed. In this method, too, the objective of this method step is the preparation of a theoretical profile of the printing speed of the entire print job. Again, this profile is composed of the individual maximum printing speeds of the respective sheets—together—within the print job. The analysis employs the same basic ideas as described above.

In block 206 of this alternative method, the sheet with the lowest maximum printing speed is now determined.

Subsequently, the predetermined value is adjusted for the profile of the printing speed of the entire print job in block 208, i.e., a constant printing speed is set for the entire print job. This adjustment of the printing profile is also performed—as in the above-described method—before printing of the print job is started. The print job is subsequently started in block 210.

In summary, it may be said that the present invention, on the one hand, is based on analyzing in advance, i.e., before a print job is started, parameters that allow a determination as to whether a change of the printing speed within a print job is practical or not, and then to take into consideration said parameters in making a decision regarding a change. In the alternative embodiment, it is assumed that, in most print jobs, a speed change within the print job is not practical overall, whereby in this case, it might be not only time aspects that are taken into consideration, so that the entire print job is adjusted to a constant low speed.

The first approach, in particular, is based on determining a measure for processing a print job. To accomplish this, a metric may be introduced, whereby said metric may be used for making comparable decisions. In the present method, this metric consists in that, first, the duration of time of a particular print job with different speed profiles is determined. Furthermore, it should be established if, and if yes, how much time can be saved by changing over the printing speed within the same print job. At this point in time, a cost-benefit analysis may be carried out because a change-over of the printing speed, as a rule, means that “costs” are incurred. In conjunction with this, for example, costs mean higher energy expenditures, the risk of a registration error and/or of errors in sheet handling caused by the printing speed change-over, potentially higher maintenance expenditures caused by “frequent” speed changes, etc. However, on the benefit side there are possible time savings with the print job and thus potentially the possibility of being able to accept more print jobs within a prespecified time. This may be of importance in particular during high-volume periods, but, more likely, not with a low volume of jobs, so that the simplified method may be selected.

Hereinabove, the invention was explained in detail with reference to specific embodiments of the invention, without, however, being restricted to said embodiments. In particular, the printing machine in which the method in accordance with the invention is being performed may be different from the printing machine that has been shown.

1. Method for preparing a profile of a printing speed of a printing machine for printing a plurality of sheets, said method comprising:
accepting a print job that defines the printing of a plurality of sheets;
analyzing the print job in view of a printing speed for each individual sheet, said analyzing comprising the determining of the printing speed for each individual sheet based on the material properties of said sheet;
preparing, before printing the sheets of the print job, the profile of the printing speed as a function of the printing speed for each individual sheet and of change-over times between different printing speeds of the printing machine.

2. Method as in claim 1, wherein a speed change-over within the profile is only ever allowed at after closed groups of sheets.

3. Method as in claim 1, wherein a speed change in the profile within a print job takes place only if a calculated savings of time exceeds a threshold value, however, if the threshold value is not exceeded, the profile of the printing speed for the entire print job is adjusted to a constant printing speed that corresponds to the lowest printing speed within the print job.

4. Method as in claim 3, wherein the threshold value is a prespecified fixed value of time.

5. Method as in claim 3, wherein the threshold value is a percentage of the printing duration of the entire print job at constant printing speed, said printing speed being adjusted to the slowest sheet.

6. Method as in claim 5, wherein the percentage is between 10% and 20%.

7. Method for preparing a profile of a printing speed of a printing machine for printing a plurality of sheets, said method comprising:
accepting a print job that defines the printing of a plurality of sheets;
analyzing the print job in view of a printing speed for each individual sheet, said analyzing comprising the determining of the printing speed for each individual sheet based on the material properties of said sheet;
determining the printing speed of the sheet with the lowest printing speed within the print job;
preparing the profile of the printing speed for the entire print job to a constant printing speed that corresponds to the lowest printing speed within the print job, with the profile being prepared before the sheets of this print job are being printed.

8. Method as in claim 1, wherein the analyzing comprises the retrieving of speed parameters of sheets specified in the print job.

9. Method as in claim 1, wherein the analyzing comprises the determining of the printing speed for each individual sheet based on the image to be printed on the sheet.

10. Method as in claim 1, wherein the analyzing comprises the determining of the printing speed for each individual sheet based on the requirements of a fusing unit.

11. Method as in claim 1, wherein the printing machine is a multi-color printing machine with a plurality of printers.

12. Method as in claim 11, wherein the multi-color printing machine comprises a duplex path.
